(19) United States
(12) Patent Application Publication
(10) Pub. No.: US 2008/0120827 A1
(43) Pub. Date: May 29, 2008

(54) Method for manufacturing a differential pH probe

(75) Inventors: John Robert Woodward, Windsor, CO (US); Leon Edward Moore, Windsor, CO (US); Russell M. Young, Fort Collins, CO (US)

Correspondence Address: THE OLLILA LAW GROUP LLC, 2060 BROADWAY, SUITE 300, BOULDER, CO, 80302, US

(73) Assignee: HACH COMPANY

(21) Appl. No.: 11/516,412

(22) Filed: Sep. 6, 2006

(51) Int. Cl. G01N 27/26

(52) U.S. Cl. 29/592.1; 156/296; 29/890.09; 29/746

(57) ABSTRACT

A method for manufacturing a differential pH probe body by forming a plurality of tube shaped segments where each of the plurality of tube shaped segments comprises a first section formed from a pH sensitive material and a second section formed from a non-pH sensitive material. Coupling the plurality of tube shaped segments together end-to-end to form the differential pH probe body where the pH sensitive sections alternate with the non-pH sensitive sections and then closing one end of the differential pH probe body.

### RELATED APPLICATIONS

This application is related to application “Differential pH probe”, and “Differential pH probe having multiple reference chambers” all filed on the same day as this application and which are hereby incorporated by reference into this application.

### BACKGROUND OF THE INVENTION

The invention is related to the field of pH measurements, and in particular, to a differential pH probe. A pH probe typically operates using an active chamber that measures a voltage across a pH sensitive material immersed in a sample. Differential pH sensors also use a reference chamber that measures a voltage across a pH sensitive material immersed in a buffer solution having a known pH, typically with a pH of 7. The differential probe uses the active voltage and the reference voltage to determine the pH of the sample. Current pH probes are typically complex designs with many fluid seals and may be large and costly to manufacture.

### BRIEF DESCRIPTION OF THE DRAWINGS

FIG. 1 illustrates glass piece 100 used in differential pH probe 150, in an example embodiment of the invention.

FIG. 2 illustrates glass piece 100 with seals, in an example embodiment of the invention.

FIG. 3 illustrates glass piece 100 with seals and circuitry, in an example embodiment of the invention.

FIG. 4 illustrates differential pH probe 150, in an example embodiment of the invention.

FIG. 5 illustrates differential pH probe 150 with temperature sensors, in an example embodiment of the invention.

FIG. 6 illustrates glass piece 137 used in a differential pH probe in an example embodiment of the invention.

FIG. 7 illustrates a variation for conductive enclosure 120 in another example embodiment of the invention.

FIG. 8a is a cross sectional view of tube segment 870 in an example embodiment of the invention.

FIG. 8b is a cross sectional view of a probe container 875 in an example embodiment of the invention.

FIG. 8c is a cross sectional view of a probe container held together with a clamping system in an example embodiment of the invention.

FIG. 8d is a cross sectional view of probe container created using tube segments of different sizes in an example embodiment of the invention.

### DETAILED DESCRIPTION OF THE PREFERRED EMBODIMENT

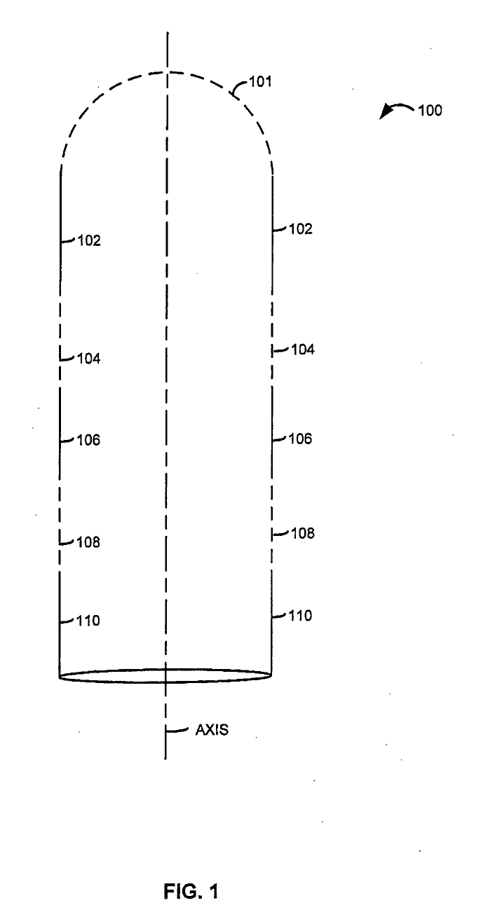

FIGS. 1-8 and the following description and exhibits depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates glass piece 100 used in differential pH probe 150, in an example embodiment of the invention. Glass piece 100 is depicted as a tube, although other suitable shapes could be used, for example a generalized cylinder. A generalized cylinder is a cylinder where the cross section can be any shape. FIG. 1 also shows glass piece 100 having a constant diameter along the length of glass piece 100. In other example embodiments of the invention glass piece 100 may not be uniform along its length, for example the different areas along the length of glass piece 100 may be different shapes and sizes. Glass piece 100 includes active areas 101, 104 and 108, in addition to, non-active areas 102, 106 and 110. Active areas 101, 104 and 108 are formed by pH sensitive glass. An example of pH-sensitive glass is lithium-ion conductive glass. Non-active areas 102, 106 and 110 are formed by non-pH sensitive glass. Note that alternative materials other than glass could be used for piece 100, such as pH-sensitive and non-pH sensitive polymers and plastics.

Note that both the active and non-active areas are integrated together to form a single piece of glass—glass piece 100. This integration could be accomplished by treating a single glass tube to form the active and non-active areas. Alternatively, the active and non-active areas could be formed separately from one another and then fused or glued together to form glass piece 100.

Note that active areas 101, 104 and 108 share the same axis making them co-axial with one another. The co-axial configuration allows for a large active area 101 while reducing the overall size of probe 150. The single piece configuration provides structural strength and requires fewer seals than a multiple piece configuration.

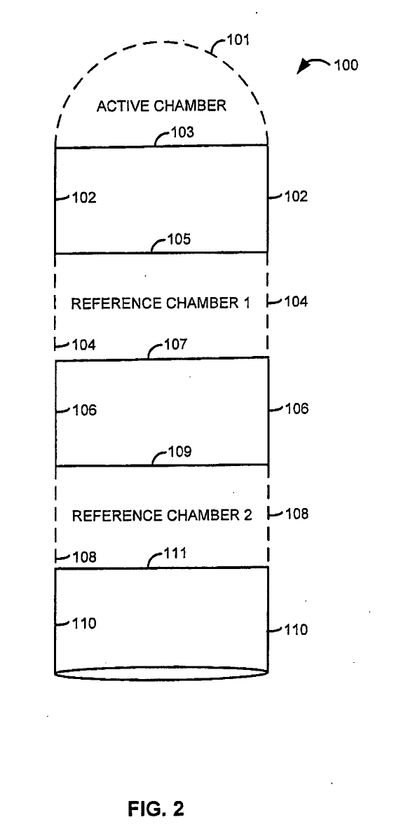

FIG. 2 illustrates glass piece 100 from FIG. 1, in an example embodiment of the invention. Glass piece 100 now has seals 103, 105, 107, 109 and 111. In one example embodiment of the invention, seals 103-111 could be rubber, silicon, or some other suitable insulating material. In other example embodiments the seals could be glass or plastic seals integrated as part of glass piece 100. Active area 101 and seal 103 form a first chamber referred to as the active chamber. Active area 104 and seals 105 and 107 form a second chamber referred to as the first reference chamber (or reference chamber one). Active area 108 and seals 109 and 111 form a third chamber referred to as the second reference chamber (or reference chamber two). In another embodiment of the invention there may be a plurality of reference chambers. The active chamber and the reference chambers may be axially aligned along the length of glass piece 100. Both the active chamber and reference chambers are typically filled with an electrolyte solution. In one example embodiment of the invention, glass piece 100 may also be called a container that is divided into the different chambers.

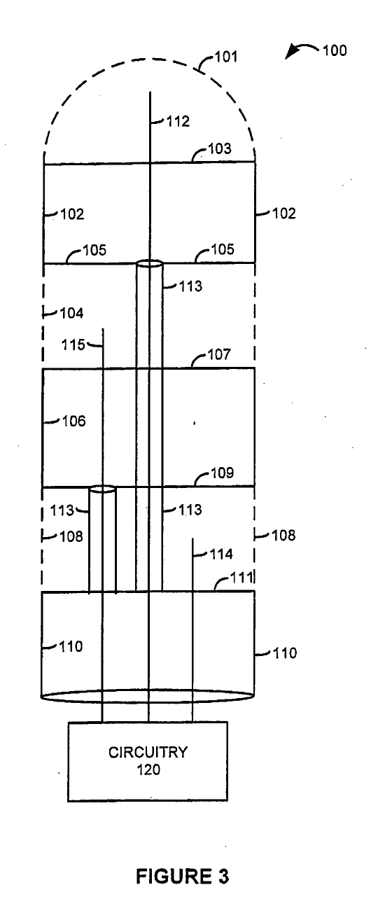

FIG. 3 illustrates glass piece 100 from FIG. 2 and also shows circuitry 120. Glass piece 100 includes active electrode 112 that is exposed within the active chamber and then runs to circuitry 120. Note that insulating tube 113 is used so that active electrode 112 runs through the reference chambers, but is not exposed within the reference chambers. Glass piece 100 also includes reference electrodes 114 and 115. Reference electrode 115 is exposed in the first reference chamber and then runs to circuitry 120 and reference electrode 114 is exposed in the second reference chamber and then runs to circuitry 120. In another example embodiment there may be a plurality of reference chambers with each reference chamber having a reference electrode running to circuitry 120.

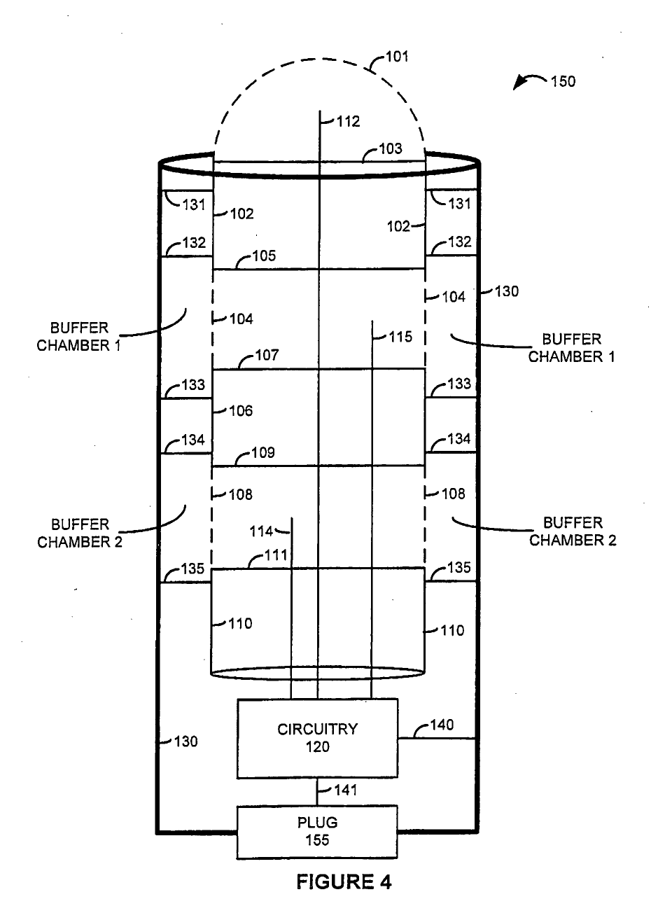

FIG. 4 illustrates differential pH probe 150 in an example embodiment of the invention. Probe 150 includes glass piece 100 and circuitry 120 as described in FIGS. 1-3. Probe 150 also includes conductive enclosure 130. Conductive enclosure 130 could be tube-shaped like glass piece 100, although other shapes could be used. In one example embodiment of the invention, glass piece 100 and circuitry 120 are placed within conductive enclosure 130. Glass piece 100 may also be called a probe container or a probe body.

Conductive enclosure 130 includes seals 131, 132, 133, 134 and 135. In this example with glass piece 100 and enclosure 130 being generally tube-shaped, seals 131-135 could be doughnut-shaped discs, although other shapes could be used in other examples. These disks could have much larger contact areas than conventional o-rings to provide better seals. Seals 131-135 could be rubber, silicon, or some other insulating material. Seals 131-132 provide a junction that allows electrical conductivity, but not fluid transfer, between buffer chamber one and the sample being tested. To provide this junction, seals 131-132 could be silicon disks with ceramic frits (tubes), where seals 131-132 are separated by a salt gel to form a salt bridge. In other embodiments a ceramic frit may be place in conductive enclosure 130 between seals 131 and 132. Seals 133-134 provide a junction that allows electrical conductivity, but not fluid transfer, between buffer chamber two and the sample being tested. To provide this junction, seals 133-134 could be silicon disks with ceramic frits (tubes), where seals 133-134 are separated by a salt gel to form a salt bridge. In other embodiments a ceramic frit may be place in conductive enclosure 130 between seals 133 and 134. Buffer chamber one is axially aligned with buffer chamber two. In one example embodiment of the invention, a salt bridge is in between the two buffer chambers. In other embodiments, the buffer chambers may be adjacent.

Seal 131 seals the end of enclosure 130 so that active area 101 of the active chamber may remain exposed to an external sample, but so that the external sample will not enter enclosure 130. Enclosure 130, seals 132-133, and active area 104 form a first buffer chamber around active area 104 of glass piece 100. Enclosure 130, seals 134-135, and active area 108 form a second buffer chamber around active area 108 of glass piece 100. The buffer chambers are axially aligned along the length of the probe. The buffer chambers are filled with a buffer solution that maintains a constant pH. In one example embodiment of the invention, the buffer solution in the two reference chambers have a different pH value, for example the first reference chamber may have a buffer solution with a pH of 7 and the second reference chamber may have a buffer solution with a pH of 5. In another example embodiment of the invention, the buffer solution in the two reference chambers may have identical pH values. In one example embodiment of the invention, glass piece 100 may have a plurality of active areas with a corresponding plurality of buffer chambers that contain buffer solutions having a wide range of different pH values. The plurality of buffer chambers may also have some buffer solutions with identical pH values. Having different buffer chambers containing buffer solutions with identical pH values allows the circuitry to detect when one of the reference chambers fails or becomes contaminated. Having multiple buffer chambers containing different buffer solutions with different pH values allows the circuitry to compensate for measurement drift and may increase the accuracy of the pH measurement of the sample.

Circuitry 120 is grounded to conductive enclosure 130 by electrical line 140. Circuitry 120 is coupled to plug 155 by electrical lines 141. Thus, circuitry 120 communicates with external systems through lines 141 and plug 155.

In operation, active area 101 of probe 150 is dipped into a sample whose pH will be determined. Note that seal 131 prevents the sample from entering enclosure 130. The sample (with unknown pH) interacts with active area 101 to produce a first voltage across active area 101. This first voltage is referred to as the active voltage and corresponds to the unknown pH of the sample. Active electrode 112 detects the active voltage and indicates the active voltage to circuitry 120.

In a similar manner, the buffer solution in the first buffer chamber (with known pH) interacts with active area 104 to produce a second voltage across active area 104. This second voltage is referred to as the first reference voltage and corresponds to the known pH of the buffer solution in the first buffer chamber. Reference electrode 115 detects the reference voltage and indicates the reference voltage to circuitry 120. The buffer solution in the second buffer chamber (with known pH) interacts with active area 108 to produce a third voltage across active area 108. This third voltage is referred to as the second reference voltage and corresponds to the known pH of the buffer solution in the second buffer chamber. Reference electrode 114 detects the reference voltage and indicates the reference voltage to circuitry 120

Circuitry 120 processes the active voltage and the two reference voltages to determine the pH of the sample. Circuitry 120 indicates the pH of the sample to external systems (not shown) that are plugged into plug 155. In one example embodiment of the invention, circuitry would process the active voltage and a plurality of reference voltages to determine the pH of the sample.

Conductive enclosure 130 is typically held by hand during testing. Note that conductive enclosure 130 electrically shields the internal components of probe 150 (electrodes 112, 114 and 115 and circuitry 120) from hand capacitance. Conductive enclosure 130 also provides a ground. Note that conductive enclosure 130 could be stainless steel, aluminum, or some other conductive material. In one example embodiment of the invention, conductive enclosure may be coated with an insulating material on the inner surface, or have an insert placed inside the inner surface, isolating the conductive enclosure from buffer chamber 1 and 2 and the salt bridges (not shown). In one example embodiment of the invention, conductive enclosure 120 may have a conducting part and a non-conducting part. The conductive part would begin just below seal 135 and would cover and shield the lower portion of the probe, including the circuitry 120. The upper portion starting just below seal 135 would be made from a non-conductive material or have a non-conductive coating. When using the two part enclosure a separate ground rod may be located in the outer salt bridge seal 121.

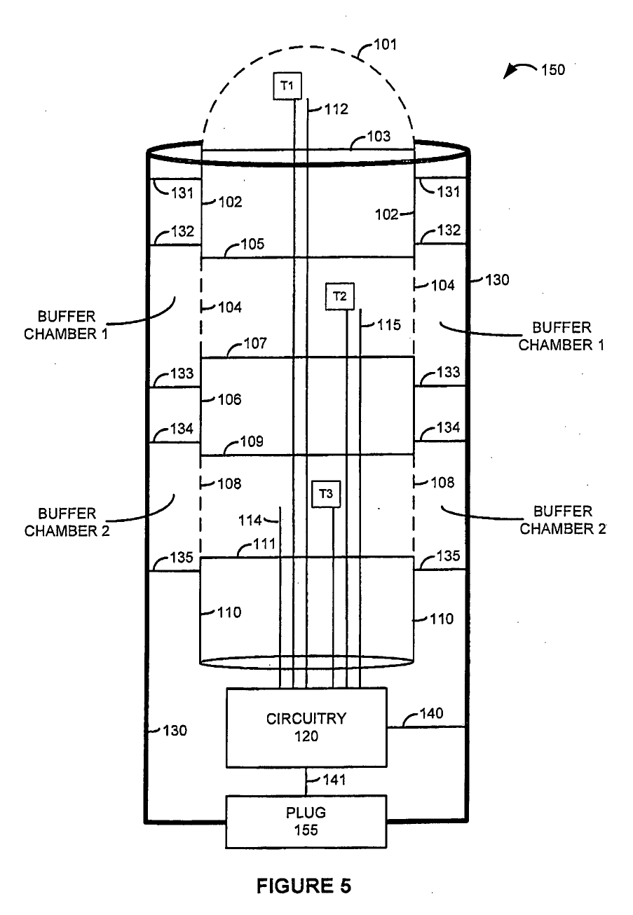

FIG. 5 illustrates differential pH probe 150 in an example embodiment of the invention. Temperature sensor T1 has been added to the active chamber to detect the temperature near active electrode 112. Temperature sensor T2 has been added to the first reference chamber to detect the temperature near reference electrode 115. Temperature sensor T3 has been added to the second reference chamber to detect the temperature near reference electrode 114. In some example embodiments of the invention, each reference chamber would have a temperature sensor. In other example embodiments, some reference chambers may not have a temperature sensor. Temperature sensor T1, T2 and T3 could be integrated within seals 103-111. Temperature sensor T1, T2 and T3 are coupled to circuitry 120. Circuitry processes the temperature information from temperature sensor T1, T2 and T3 to provide temperature compensation during the pH determination. In another embodiment of the invention, temperature sensor T1 may be located on the outside of the active chamber (not shown) and be exposed to the sample and used to detect the temperature of the sample. In another embodiment of the invention, temperature sensors T2 and T3 may be located in the buffer chambers.

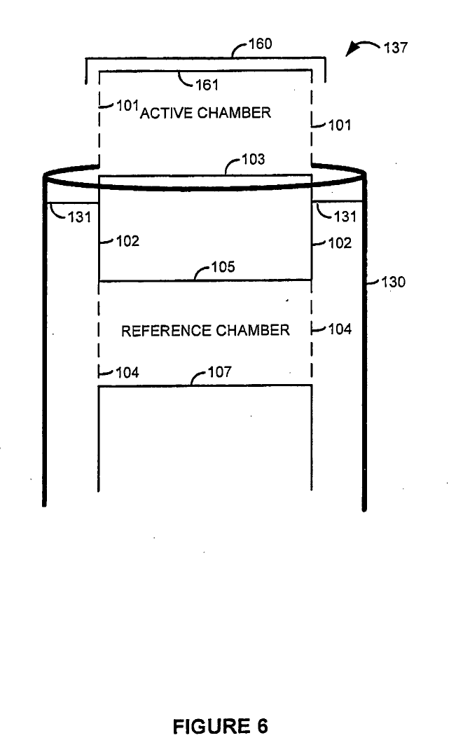

FIG. 6 illustrates an alternative to glass piece 100. Note that some details from the previous figures are omitted for clarity. Glass piece 137 is now used for probe 150 instead of glass piece 100. Glass piece 137 is similar to glass piece 100 with active areas 101, 104 and 108 (not shown) and non-active areas 102, 106 and 110 (not shown). The variation from glass piece 100 is in the shape of the active chamber. Active area 101 is no longer a dome at the top of the glass piece, but is now formed by the walls of glass piece 137 in the same way that active area 104 forms the first reference chamber. Thus, the active chamber has the same geometry as the reference chambers. Non-active glass 161 is used at the top of the active chamber, although a seal could be used instead of non-active glass 161 if desired. The top of the active chamber may be protected by cap 160. Cap 160 could be rubber, metal, or some other protective material that is adhered to glass piece 137.

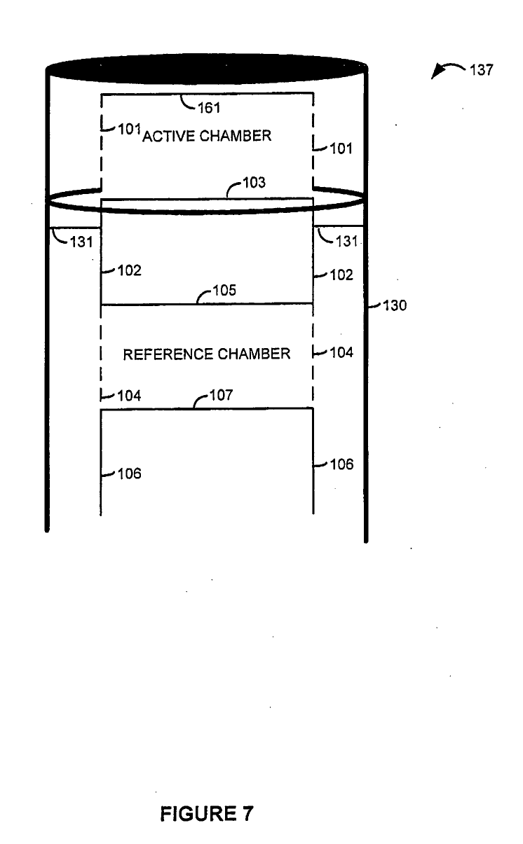

FIG. 7 illustrates a variation for conductive enclosure 130. Note that some details from the previous figures are omitted for clarity. Glass piece 137 is used, but glass piece 100 could be used as well. Enclosure 130 now extends above the active chamber of glass piece 137 to provide protection. The extension of enclosure 130 must still allow the sample to contact active area 101, so openings in enclosure 130 should be provided for this purpose. The sample should still not be allowed to pass seal 131.

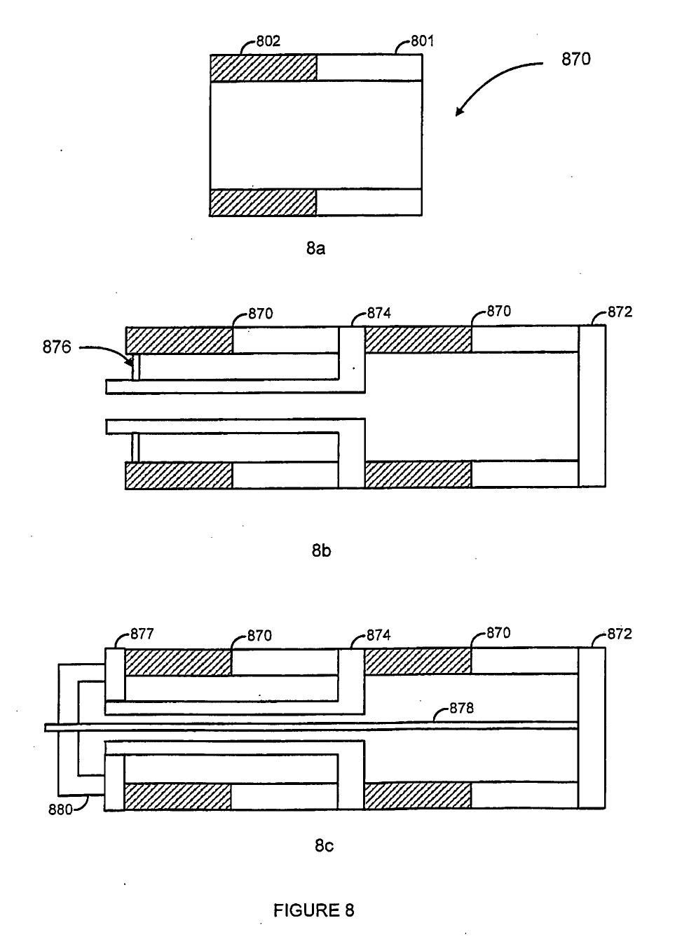

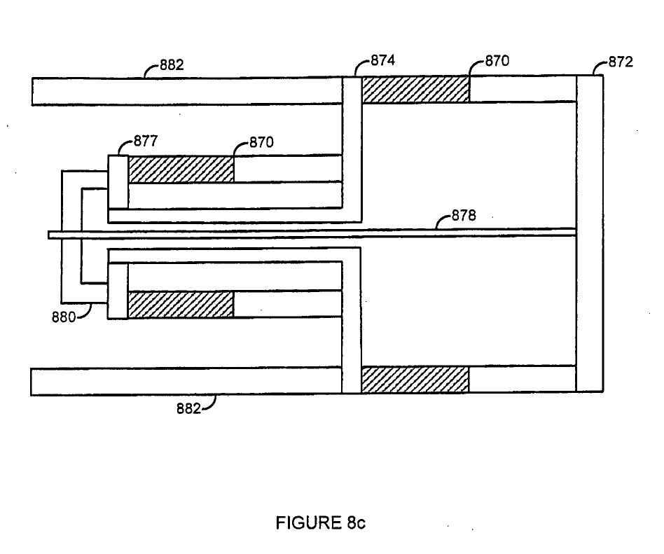

As discussed above, the active and non-active areas of the probe may be formed separately and then joined together to form the probe container. Active pH sensitive material can be molded, drawn or machined into hollow tubes. In one example embodiment of the invention, a hollow rod or tube of pH sensitive material and a hollow rod or tube of non-pH sensitive material are cut into a plurality of sections. The end of a section of the pH sensitive material is attached to the end of a section of the non-pH sensitive material. FIG. 8a is a cross sectional view of tube segment 870 in an example embodiment of the invention. Tube segment 870 comprises a tube section of the pH sensitive material 801 attached to a tube section of the non-pH sensitive material 802. A plurality of tube segments 870 may be joined together to form a length of tube with alternating sections of pH sensitive and non-pH sensitive material. A flat or domed end cap may be attached to one end of the length of tube to form a glass piece similar to glass piece 137 or to glass piece 100. In one example embodiment of the invention, the tube segments 870 may be permanently joined together by welding or gluing the ends of the segments together. In another example embodiment of the invention, the tube segments 870 may be joined together with glass or plastic sealing rings between each of the tube segments. The tube segments may have any cross sectional shape, for example a square, but a circle is the cross sectional shape for the preferred embodiment.

FIG. 8b is a cross sectional view of a probe container 875 in an example embodiment of the invention. Probe container 875 may also be called a probe body. Probe container 875 comprises two of tube segments 870, an end cap 872, seal 876 and sealing ring or spacer 874. The two tube segments 870 are joined together with sealing ring 874 captured between the two tube segments 870. End cap 872 is attached to the open end of the two joined tube segments and a seal 876 is inserted into the other end of the joined tube segments, forming two axially aligned chambers inside the probe container. Sealing ring 874 and end cap 872 may be fabricated from glass, plastic or the like and welded or glued to the tube segments 870. Using different shaped spacer rings, additional chambers may be added to probe container 875 to form a probe container with a plurality of chambers. The tube segments 870 with alternating pH and non-pH sensitive material used to create a probe container do not need to be the same size or shape. In one example embodiment of the invention the different chambers that comprise a probe container may not have the same size or shape.

In another embodiment of the invention, the tube segments may be held together with a clamping system. FIG. 8c is a cross sectional view of a probe container 885 held together with a clamping system in an example embodiment of the invention. Probe container 885 comprises two of the tube segments 870, an end cap 872, back plate 877, sealing ring or spacer 874, clamping rod 878 and nut 880. The two tube segments 870 are joined together with sealing ring 874 captured between the two tube segments 870. End cap 872 is located in the open end of the two joined tube segments. Back plate 877 is located on the opposite end of the two joined tube segments from the end cap 872. Clamping rod 878 is attached to the end cap 872 and runs through the center of probe container 885. Nut 880 attaches to clamping rod 878 and forces back plate 877 against the two joined tube segments 870, compressing the parts together and forming two axially aligned chambers inside the probe container. Additional tube segments 870 may be added to increase the number of chambers in probe container 885 to form a probe container with a plurality of chambers. In some example embodiments of the invention, some type of gasket, for example an o-ring, may be used at one or more of the joints to help form fluid tight seals.

The tube segments with alternating pH and non-pH sensitive material used to create the probe container do not need to be the same size or shape. FIG. 8d is a cross sectional view of probe container 890 created using tube segments of different sizes in an example embodiment of the invention. Probe container 890 comprises tube segments 870, tube segment 871, end cap 872, back plate 877, sealing ring or spacer 874, clamping rod 878, nut 880 and conductive enclosure 882. Sealing ring 874 is captured between the end of tube segment 870 and the end of tube segment 871. End cap 872 is located at one end of the joined tube segments and back plate 877 is located at the opposite end of the joined tube segments. Clamping rod 878 is attached to end cap 872 and runs through the middle of the two tube segments. Nut 880 attaches to clamping rod 878 and acts against back plate 877, forcing back plate 877, tube segment 870, sealing ring 874, tube segment 871 and end cap 872 together to form two axially aligned chambers inside the probe container. Conductive enclosure 882 is attached to sealing ring 874. In some example embodiments of the invention the clamping system may be integrated with conductive enclosure (not shown). Additional tube segments 870 may be added to increase the number of chambers in probe container 890 to form a probe container with a plurality of chambers. In some example embodiments of the invention, some type of gasket, for example an o-ring, may be used at one or more of the joints to help form fluid tight seals.

We claim:

1. A method of manufacturing a differential pH probe body, comprising:
forming a plurality of tube shaped segments where each of the plurality of tube shaped segments comprises a first section formed from a pH sensitive material and a second section formed from a non-pH sensitive material;
coupling the plurality of tube shaped segments together end-to-end to form the differential pH probe body where the pH sensitive sections alternate with the non-pH sensitive sections;
closing one end of the differential pH probe body.

2. The method of manufacturing a differential pH probe body of claim 1 where the one end of the differential pH probe body is closed with a dome shaped pH sensitive material attached to an end of the differential pH probe body having a non-pH sensitive section of the tube.

3. The method of manufacturing a differential pH probe body of claim 1 where the one end of the differential pH probe body is closed with a flat piece of non-pH sensitive material attached to an end of the differential pH probe body having a pH sensitive section of the tube.

4. The method of manufacturing a differential pH probe body of claim 1 where the plurality of tube shaped segments are coupled together permanently.

5. The method of manufacturing a differential pH probe body of claim 1 where the plurality of tube shaped segments are coupled together using a clamping system.

6. The method of manufacturing a differential pH probe body of claim 1 where at least a first one of the plurality of tube shaped segments has a first diameter and at least a second one of the plurality of tube shaped segments has a second diameter and the first diameter is different than the second diameter.

7. The method of manufacturing a differential pH probe body of claim 1 where at least a first one of the plurality of tube shaped segments has a first length and at least a second one of the plurality of tube shaped segments has a second length and the first length is different than the second length.

8. The method of manufacturing a differential pH probe body of claim 1 where at least a first one of the plurality of two tube shaped segments has a first shape and at least a second one of the plurality of tube shaped segments has a second shape and the first shape is different than the second shape.

9. A method of manufacturing a differential pH probe, comprising:
forming a plurality of tube shaped segments where each of the plurality of tube shaped segments comprises a first section formed from a pH sensitive material and a second section formed from a non-pH sensitive material;
coupling at least two of the plurality of tube shaped segments together end-to-end to form a probe body where the pH sensitive sections alternate with the non-pH sensitive sections;
closing one end of the probe body near a first section of pH sensitive material;
dividing the probe body into a first, a second and a third chamber where the first chamber corresponds to the first section of pH sensitive material, the second chamber corresponds to a first section of non pH sensitive material, and the third chamber corresponds to a second section of pH sensitive material;
inserting a first electrode into the first chamber and a second electrode into the third chamber and connecting the first and second electrodes to circuitry;
immersing the second ring of pH sensitive material in a buffer solution.

10. The method of manufacturing a differential pH probe of claim 9 where the at least two of the plurality of tube shaped segments are coupled together permanently.

11. The method of manufacturing a differential pH probe of claim 9 where the at least two of the plurality of tube shaped segments are coupled together using a clamping system.

12. The method of manufacturing a differential pH probe of claim 9 where a first one of the at least two tube shaped segments has a first diameter and a second one of the at least two tube shaped segments has a second diameter and the first diameter is different than the second diameter.

13. The method of manufacturing a differential pH probe of claim 9 where a first one of the at least two tube shaped segments has a first length and a second one of the at least two tube shaped segments has a second length and the first length is different than the second length.

14. The method of manufacturing a differential pH probe of claim 9 where a first one of the at least two tube shaped segments has a first shape and a second one of the at least two tube shaped segments has a second shape and the first shape is different than the second shape.

15. The method of manufacturing a differential pH probe of claim 9, further comprising:
surrounding the second and third chambers with a conductive enclosure and connecting a ground path in the circuitry to the conducting enclosure.

16. The method of manufacturing a differential pH probe of claim 15, further comprising:
coupling a first seal and a second seal to an outer surface of the probe body and an inner surface of the conductive enclosure to form a compartment that holds the buffer solution.

17. The method of manufacturing a differential pH probe of claim 9, further comprising:
inserting a first temperature sensor into the first chamber and a second temperature sensor into the third chamber and connecting the first and second temperature sensor to the circuitry.

18. A method for manufacturing a differential pH probe, comprising:
dividing a container having an outer surface and an inner volume into a first plurality of chambers;
forming a plurality of pH-sensitive areas where one of the plurality of pH-sensitive areas is on the outer surfaces of each of the first plurality of chambers and where a first one of the plurality of pH-sensitive areas is configured to be exposed to a sample;
exposing each one of the plurality of pH-sensitive areas, except the first one of the plurality of pH-sensitive areas, to one of a plurality of buffer solutions having a range of different pH's;
installing a plurality of electrodes into the first plurality of chambers where each one of the plurality of electrodes is configured to detect a voltage in one of the first plurality of chambers;
connecting the plurality of electrodes to circuitry configured to process the plurality of voltages to determine a pH of the sample.

19. The method for manufacturing a differential pH probe of claim 18 further comprising:
forming a second plurality of chambers where the outer surface of the second plurality of chambers is not pH sensitive and where one of the second plurality of chambers is between each of the first plurality of chambers.

20. The method for manufacturing a differential pH probe of claim 18 further comprising:
installing a temperature sensor in the chamber having the first one of the plurality of pH-sensitive areas on the outer surface of the chamber where the temperature sensor is coupled to the circuitry and where the circuitry is configured to compensate the determined pH for the temperature sensed in the chamber having the first one of the plurality of pH-sensitive areas on the outer surface of the chamber.

21. The method for manufacturing a differential pH probe of claim 18 where each one of the plurality of buffer solutions has a different pH.

22. The method for manufacturing a differential pH probe of claim 18 where the container has a generalized cylindrical shape and a cross section of the generalized cylindrical shape is selected from one of the following: circle, square, rectangle, regular polygon, star polygon, ribbed circle, rounded rectangle, oval, spline, and ellipse.

23. The method for manufacturing a differential pH probe of claim 18 further comprising:
installing a conductive enclosure where the conductive enclosure surrounds the plurality of pH-sensitive areas except for the first one of the plurality of pH-sensitive areas and where the conductive enclosure is coupled to a ground path in the circuitry.

24. The method for manufacturing a differential pH probe of claim 23 further comprising:
installing a plurality of seals located between the conductive enclosure and the outer surface of the container and forming a plurality of compartments that contain the plurality of buffer solutions.

25. The method for manufacturing a differential pH probe of claim 24 where the plurality of compartments are axially aligned.

26. The method for manufacturing a differential pH probe of claim 18 where at least two of the plurality of buffer solutions have the same pH.
